(19) United States
(12) Patent Application Publication
(10) Pub. No.: US 2008/0195333 A1
(43) Pub. Date: Aug. 14, 2008

(54) Method and Device for Categorizing Damage to a Roller Bearing

(76) Inventors: Dietrich Behr, Clausthal-Zellerfeld (DE); Jens Strackeljan, Magdeburg (DE)

Correspondence Address: MICHAEL J. STRIKER, 103 EAST NECK ROAD, HUNTINGTON, NY, 11743, US

(21) Appl. No.: 11/909,989

(22) PCT Filed: Mar. 31, 2006
(86) PCT No.: PCT/DE06/00583

§ 371 Date: Sep. 28, 2007

(30) Foreign Application Priority Data
Apr. 4, 2005 (DE) 20 2005 015 465.4

(51) Int. Cl. G01M 13/04

(52) U.S. Cl. 702/56; 73/593

(57) ABSTRACT

The invention relates to a method and a test and analytical device for categorizing antifriction bearing damages. The invention is characterized in that analysis preceding categorization comprises statistically evaluating the jerk of a structure-borne noise signal to which the movement of the antifriction bearing to be inspected contributes.

The present invention is related to a method for categorizing damage to a roller bearing integrated in a device that includes the steps:
Record a signal that represents the structure-borne vibrations of the device,
Analyze the signal in terms of at least one specified signal characteristic,
Assign the signal to a predetermined damage category based on the result of the analysis.

The present invention also relates to a measuring and analytical device for categorizing damage to a roller bearing integrated in a device that includes:
A sensor for recording a signal that represents the structure-borne vibrations of the device, a digital data memory for storing the recorded signal,
A digital arithmetic unit for processing the stored signal,
A digital program memory for storing instructions, rules, and default values for controlling the processing of the stored signal,
Output means for outputting a result of the processing of the stored signal,
   the instructions, rules, and default values stored in the program memory being suitable for analyzing the stored signal in terms of at least one specified signal characteristic, assigning the stored signal to a predetermined damage category based on the result of the analysis, and allowing the output of this damage category—as the result of the processing—via the output means.

Identifying and categorizing damage to roller bearings integrated in devices such as engines, machines, pumps, etc., is an essential measure for guaranteeing reliable operation of the devices and for preventing greater damage, which could occur, e.g., due to bearing failure, shafts and axles running out of true, etc. To detect and categorize damage, it is very important in terms of minimizing cost to not have to remove the bearing to be inspected from the device and disassemble it, e.g, in order to inspect it visually.

A number of methods are therefore known that may be used to detect and categorize damage to roller bearings by analyzing acoustic signals, the acoustic signals being based on structure-borne vibrations of the running device. The structure-borne vibrations are also enhanced, in particular, by the components of vibration caused by the movement of the bearing(s) to be investigated. The simplest analytical method is to listen to the running device using a stethoscope, although the analysis itself is based largely on the investigator's experience. Various approaches do exist for automating the analytical method and designing it to be independent of an investigator's level of experience.

Publication DE 199 38 722 A1 discloses a method of this type, with which the spectral graph of the structure-borne vibrations of the running device are recorded and analyzed with reference to a dynamic model. Special knowledge about the device and the bearing to be investigated, e.g., the bilateral contact stiffnesses of the roller bearings with the bearing shells, is incorporated in the dynamic model, so that the transfer function between the bearing and the measuring and analytical device may be determined as accurately as possible. This requirement of special knowledge is a considerable disadvantage of the known method. This disadvantage is inherent in all frequency-based measuring methods, since the vibration frequencies measured depend to a considerable extent on the number of revolutions of the bearing, the number of roller bearings, the diameter of the roller bearings and the bearing shells, etc.

An object of the present invention is to refine a generic method so that damage may be categorized reliably even without knowledge of special bearing and operating parameters.

A further object of the present invention is to refine a generic device so that damage may be categorized reliably even without knowledge of special bearing and operating parameters.

These objects are attained in combination with the features described in the preambles of claims 1 through 16 by the fact that the analysis includes a statistical evaluation of an analytical function of the signal derived from the recorded signal in order to determine the characteristic value of the specified signal characteristics, the analytical function being a derivative of the signal that is the jerk of the structure-borne noise represented, or it is a higher derivative.

The basic idea behind the present invention is to perform a statistical analysis of the “jerk”, i.e., the second derivative with respect to time of the structure-borne signal—which is proportional to velocity—or to take a higher derivative, and to use it to support the categorization of the damage. This is basically a special investigation of properties of the extreme value ranges of the signal, which is proportional to velocity. It has been empirically demonstrated that specifically the information content in the region of extreme values of the structure-borne signal—which is proportional to velocity—is characteristic for various types of damages which occur to bearings. A correlation may be roughly visualized by imagining microscopic impacts experienced by a rolling element, which are very short when bearing shells are smooth, and which are longer when bearing shells have been roughened, i.e., when they are already damaged. A detailed physical model for this correlation is not known, however. However, the fact that there is a correlation between the shape of the extreme-value ranges in the signal—which is proportional to speed—and the damage category is a surprising discovery. The present invention uses this discovery in an advantageous manner.

Compared with a direct investigation of extreme values in the velocity-dependent signal, the inventive method—in which a statistical analysis of the jerk is considered—has various advantages. For example, it is possible but not necessary to detect the structure-borne vibrations of the running device in a manner that is proportional to speed. As an alternative, the signal may be measured in a manner that is proportional to deflection or acceleration. In these cases, the relevant jerk would be calculated as the third derivative, or as the first derivative with respect to time of the recorded signal. The inventive method also has the advantage that a statistical analysis of a signal is much simpler and requires less computation than the separate investigation of a large variety of individual extreme values in a time signal that is proportional to velocity.

It should be noted that the term “signal characteristic” refers to a general property, i.e., a function of the signal under consideration, while—within the framework of this description—“characteristic value” refers to the specific property, i.e., the special values of the function on a signal that is actually being investigated.

Advantageously, a mean of analytical functional values, i.e., of actual values of the calculated jerk, at the points of local extreme values of a velocity function derived from the recorded signal is a specified signal characteristic. The “velocity function” refers to the velocity of the structure-borne vibration represented by the recorded signal. When carrying out a structure-borne measurement that is proportional to velocity, the velocity function is therefore equal to the recorded signal. When carrying out a structure-borne measurement that is proportional to deflection, however, the velocity signal is calculated using the first derivative with respect to time of the recorded signal, and, when carrying out a measurement that is proportional to acceleration, it is calculated using the first integral with respect to time of the recorded signal. Specifically, in this embodiment, a mean of the values of the jerk that correlate with respect to time with the local extreme values of the velocity function is calculated. It has been demonstrated empirically that this value is characteristic for various types of damages to roller bearings, and that determining it is therefore often sufficient to categorize damage in a reliable manner. It should be noted that the term “mean” includes different types of means calculations. Examples include the arithmetic mean, the median, and the root-mean-square value, although other types of means calculations may also be used. The arithmetic mean is preferred.

In an alternative embodiment, it is provided that a frequency distribution of analytical function values at the points of local extreme values of a velocity function derived from the recorded signal is a specified signal characteristic. In other words, a histogram of jerk values at the points of velocity extremes is calculated and is used to categorize damage. Since a histogram of this type contains more information than a simple mean, it is understandable that this embodiment allows finer subdivisions of different damage categorizations to be carried out.

Although it is typically not necessary, it is also possible, of course, to use the mean and the histogram together to categorize damage.

In every case, damage is categorized by making a comparison with stored reference values that were determined—either empirically or via computation—to be characteristic or typical for different damage categories.

In an advantageous refinement of the present invention, it may be provided that a fluctuation of distances between adjacent points of local extreme values of the velocity function is an additional specified signal characteristic. This value, which may correspond, e.g., to the statistical variance of distances between extremes, is preferably determined directly from the velocity function. The distance may be determined between directly adjacent extreme values having the same or opposite signs, or between less directly adjacent extreme values having the same or opposite signs. The distance is preferably determined between directly-adjacent extreme values having the same sign.

In a further favorable embodiment of the present invention, it is provided that a frequency distribution of values of distances between adjacent points of local extreme values of the velocity function is an additional specified signal characteristic. In this case as well, it is provided that a histogram of distances between extremes be calculated, as an alternative or in addition to the determination of an individual value, i.e., the fluctuation of distances between extremes, thereby resulting in a finer differentiation between different types of damage. It should be noted, however, that a substantially greater amount of computing effort is required to calculate a histogram than is required to calculate an individual value, and this additional effort must stand in a reasonable proportion to the advantage that may be attained by having a finer categorization.

In a further embodiment of the present invention, it is provided that the number of local extreme values of the velocity function with absolute values above a specified threshold value is an additional specified signal feature. This essentially corresponds to an analysis of the amplitude of the velocity signal. Advantageously, the absolute value is determined before the velocity function is normalized, and it is preferably determined with the effective value of the velocity function. This normalization results in the method being independent of the absolute “volume” of the structure-borne signal that is recorded.

As mentioned above, after the actual characteristic values of the selected signal characteristic(s) is/are determined, the damage is assigned to a category, i.e., the measured signal is assigned to a damage category. If the analysis was carried out based on a plurality of signal characteristics, the assignment is preferably carried out based on a defined metric in a multidimensional characteristic space. The signal to be assigned is positioned in the characteristic space based on its characteristic values of the signal characteristics that define the characteristic space, and the distance—calculated per the defined metric—from points or areas in the multidimensional space that represent predefined damage categories is calculated. This means that points or areas ascertained in the multidimensional space, either empirically or via computation, represent certain damage categories, to one of which the recorded signal is to be specifically assigned. This is carried out by determining the distance between the point in the multidimensional space that represents the recorded signal to the predefined points or areas. The meaning of “distance” is specified by the predefined metric. For example, the signal characteristics that define the characteristic space may be subdivided into generalized units, and the distance may be defined as an n-dimensional, Euclidian metric. The special transformation of the signal characteristics to the generalized units of the characteristic space may be selected such that the particular significance of the characteristic is taken into account when making a distinction between categories. It is also possible, of course, to define other metrics as the Euclidian metric.

The signal is preferably assigned to the damage category that is the minimum distance away in the characteristic space per the defined metric.

Cases are also feasible in which the minimum distance value may not be determined unambiguously. This may occur, in particular, when tolerances are permitted in the distance determination, e.g., in order to take measurement inaccuracies into account. It may then happen that two or more calculated distances are located within the permissible tolerances. It would therefore not be possible to determine an unambiguous minimum. In an advantageous refinement of the present invention, it is therefore provided that, in a case such as this, at least one characteristic dimension is added to the characteristic space, and the signal is classified once more and the distance is redetermined. In this manner, the categorization is refined by also taking an additional signal characteristic into account.

In an alternative embodiment, it is provided that, if a minimum distance value may not be determined unambiguously, the metric on which it is based is changed, and the distance of the signal is redetermined. In other words, the meaning of the term “distance” is redefined in this case.

In the actual implementation of the present invention in the form of a measuring and analytical device, it is basically possible to code the inventive method in a suitable manner in instructions, rules, and default values, i.e., to code it in the form of a program and to run it on a data processing device that includes suitable interfaces with a related sensor. It is particularly favorable when the data and program memory, arithmetic unit, and output means are integrated in a portable, hand-held device, and the sensor—as an external element—is connectable thereto using a cable or wireless connection. To accelerate the measuring and categorizing process, the arithmetic unit may be designed as a specially-equipped microprocessor, i.e., as a specially programmed DSP (digital signal processor) in particular, and the individual instructions and rules may be implemented via the software or hardware. The default values, i.e., reference values required for the categorization in particular, may be implemented in a separate data base, preferably via software. It is particularly favorable when the data base may be expanded by incorporating actual measurements.

Potential sensors are sensors used to measure structure-borne vibrations that generate a signal that is proportional to deflection, velocity, or acceleration. Particularly advantageously, inductive sensors are used, the coupling of which with the device containing the roller bearing does not implement a low-pass filter. Due to the high derivative to be calculated, i.e., the jerk, a high sampling frequency is required, preferably in the range of a few 100 kHz to a few MHz. Slow-reacting sensors that perform low-pass are therefore less suitable. The basic tendency of the method toward high frequency also makes it possible to measure devices that run very rapidly, such as vacuum pumps and high-frequency motors.

Machines to be inspected for damage to roller bearings typically contain several roller bearings of the same type or different types. The inventive measurement may then be carried out at several points on the machine surface, and the roller bearing that is acoustically most effectively coupled with the measurement point makes the greatest contribution to the signal that is recorded.

Further features and advantages of the present invention result from the special description below, and from the drawing.

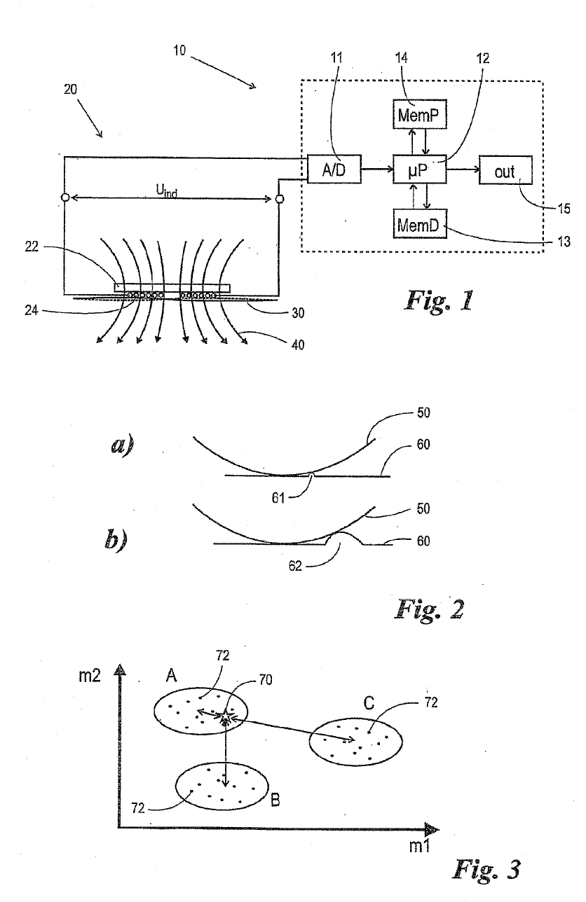

FIG. 1: Shows a schematic depiction of a measuring and analytical device according to the present invention;

FIG. 2: Shows a schematic sketch to illustrate different categories of roller bearing damage;

FIG. 3: Shows a schematic depiction of the categorization of damage to a roller bearing that was measured, in a two-dimensional characteristic space.

FIG. 1 shows a schematic depiction of a measuring and analytical device for categorizing damage to roller bearings. The entire device includes a portable hand-held device 10 and a sensor 20 that is connectable thereto. The sensor is placed on surface 30 of the device that contains the bearing(s). With machines that contain several roller bearings that must be inspected regularly for damage, it may be favorable to permanently attach a sensor at each of several points in the vicinity of bearings. For inspection individual sensors 20 are connected to a measuring device 10 in succession or simultaneously.

In the embodiment shown, sensor 20 is essentially composed of a permanent magnet 22, on which a spiral coil 24 is installed, e.g., it is glued thereon. The sensor is attached to a surface 30 of a machine to be investigated. Sensors, which are not shown in FIG. 1, are integrated in the machine to be investigated. When the machine is operated, structure-borne vibrations—which include the movements of roller bearings—of surface 30 are produced. In FIG. 1, the structure-borne vibrations are depicted schematically as waves of surface 30 (solid lines and dashed lines). Given a ferromagnetic surface 30, sensor 20 is preferably attached to surface 30 via the force of permanent magnet 22. It is also possible, of course, to bond magnet 22 and coil 24 to surface 30, or to attach it in another manner, e.g., using a screw connection.

The constant magnetic field of permanent magnet 22 passes through coil 24, which is insulated against surface 30, and it passes through surface 30 itself. Magnetic field lines 40 are distorted by the vibrations of surface 30. As such, coil 24 is located in a magnetic field that changes with respect to time, which results in induction of a voltage U_{ind}. Voltage U_{ind} is a representation—that is proportional to velocity—of the vibrations of surface 30. Voltage U_{ind} is digitized using an A/D converter 11, and it is forwarded to a microprocessor, μP, 12 for further processing. Microprocessor 12 communicates with a data memory, MemD, 13, in which the recorded signal may be stored, and with a program memory, MemP, 13, in which rules, instructions, and default values for processing the recorded signal are stored. The result of the data processing is displayed to the user as luminescent signals in a special display field on an output 15 (out), which may be realized in the form of a conventional screen display, or which may be realized in another manner.

In the embodiment shown in FIG. 1, A/D converter 11, microprocessor 12, memories 13 and 14—which may be designed separately or as a unit—and output 15 are integrated in a portable, hand-held device (dashed box). The connection with sensor 20 is realized as a cable connection, preferably as a coaxial cable connection. It is also possible, as an alternative, to position A/D converter 11 at the site of transmitter 20, and to transfer a digital signal to the hand-held device. The digital signal may be transmitted across a wireless path. It is also possible, of course, to send the recorded data to a conventional PC and to continue the analysis there.

FIG. 2 shows—in a highly schematicized and simplified version—two different types of categories of damage to roller bearings, to suggestively illustrate the relationship between the damage category and the actual calculation of extreme values in the recorded velocity signal. It should be noted that this is not a physical model, it is an attempted illustration. A rolling element 50, which may be designed, e.g., as a ball or a roller, rolls along on the surface of a bearing shell 60. In the case shown in FIG. 2a, bearing shell surface 60 has very small areas of unevenness 61. In FIG. 2b, however, they have broader and higher areas of unevenness 62. It is immediately obvious that, in the case of FIG. 2a, the microscopic impacts that result when rolling element 50 rolls over the uneven areas are very short, but they are much longer in the case shown in FIG. 2b. This results in a change in the form of the extreme values of the signal, which is proportional to velocity.

FIG. 3 is a simplified illustration of the actual categorization of damage. A recorded signal is analyzed based on several (only two in this case, for simplicity) signal characteristics m1 and m2, and it is positioned in the characteristic space defined by m1 and m2. In this case, the current signal is shown as an asterisk 70. A large number of points 72 is also positioned in the characteristic space; these points represent a signal that was measured earlier and which belongs to a known category of damage. It has been shown that the inventive analytical method is suitable for delineating damage categories from each other as areas in the characteristic space. Three areas A, B, and C are shown in the example depicted. To automatically categorize signal 70 being measured currently, the distances between signal 70 and points 72, or a point that is representative of an area A, B, C, are measured and compared. Signal 70 is then assigned to the damage category that is the minimum distance away. It is category A in this example.

The embodiments presented in the special description and in the figures are merely illustrative exemplary embodiments of the present invention, of course. The dimensionality of the characteristic space depends, in particular, on the fineness of categorization desired. It is not a prerequisite of the present invention that sensor 20 described above have the embodiment shown. Rather, any type of sensor may be used that is capable of generating a signal that represents the structure-borne vibration.

What is claimed is:

1. A method for categorizing damage to a roller bearing integrated in a device that includes the steps:
Record a signal that represents the structure-borne vibrations of the device,
Analyze the signal in terms of at least one specified signal characteristic,
Assign the signal to a predetermined damage category based on the results of the analysis,
wherein
the analysis includes a statistical evaluation of an analytical function of the signal derived from the recorded signal in order to determine the characteristic value of the specified signal characteristics, the analytical function being a derivative of the signal that is the jerk of the structure-borne noise represented, or it is a higher derivative.

2. The method as recited in claim 1,
wherein
a mean of analytical function values at the points of local extreme values of a velocity function derived from the recorded signal is a specified signal characteristic, the velocity function representing the velocity of the structure-borne vibration represented by the recorded signal.

3. The method as recited in claim 1,
wherein
a frequency distribution of analytical function values at the points of local extreme values of a velocity function derived from the recorded signal is a specified signal characteristic, the velocity function representing the velocity of the structure-borne vibration represented by the recorded signal.

4. The method as recited in claim 2,
wherein
a fluctuation of distances between adjacent points of local extreme values of the velocity function is an additional specified signal characteristic.

5. The method as recited in claim 2,
wherein
a frequency distribution of values of distances between adjacent points of local extreme values of the velocity function is an additional specified signal characteristic.

6. The method as recited in claim 2,
wherein
the number of local extreme values of the velocity function with absolute values above a specified threshold value is an additional specified signal characteristic.

7. The method as recited in claim 6,
wherein,
the velocity function is normalized before the absolute values are determined.

8. The method as recited in claim 7,
wherein,
the normalization is carried out using the effective value of the velocity function.

9. The method as recited in claim 1,
wherein
the analysis is carried out based on a plurality of signal characteristics, and the signal is assigned to a damage category in a multidimensional characteristic space based on a defined metric; the signal to be assigned is positioned in the characteristic space based on its characteristic values of the signal characteristics that define the characteristic space, and the distance from points or areas in the multidimensional space that represent predefined categories of damage is calculated.

10. The method as recited in claim 9,
wherein
the signal is assigned to the damage category that is the minimum distance away in the characteristic space per the defined metric.

11. The method as recited in claim 10,
wherein
if a minimum distance value may not be determined unambiguously, at least one characteristic dimension is added to the characteristic space, and the signal is classified once more and the distance is redetermined.

12. The method as recited in claim 10,
wherein
if a minimum distance value may not be determined unambiguously, the metric on which it is based is changed, and the distance of the signal is redetermined.

13. The method as recited in claim
wherein
the signal that is recorded represents the velocity of the structure-borne vibration.

14. The method as recited in claim 1,
wherein
the signal that is recorded represents the acceleration of the structure-borne vibration.

15. The method as recited in claim 1,
wherein
the signal that is recorded represents the deflection of the structure-borne vibration.

16. A measuring and analytical device for categorizing damage to a roller bearing integrated in a device that includes:
A sensor (20) for recording a signal that represents the structure-borne vibrations in the device (30),
A digital data memory (13) for storing the recorded signal,
A digital arithmetic unit (12) for processing the stored signal,
A digital program memory (14) for storing instructions, rules, and default values for controlling the processing of the stored signal,
Output means (15) for outputting a result of the processing of the stored signal,
the instructions, rules, and default values stored in the program memory (14) being designed to analyze the stored signal in terms of at least one specified signal characteristic, assign the stored signal to a predetermined damage category based on the result of the analysis, and to allow the output of this damage category—as the result of the processing—by the output means
wherein
the analysis includes a statistical evaluation of an analytical function of the signal derived from the recorded signal in order to determine the characteristic value of the specified signal features, the analytical function being a derivative of the signal that is the jerk of the structure-borne noise represented, or it is a higher derivative.

17. The measuring and analytical device as recited in claim 16,
wherein
a mean of analytical function values at the points of local extreme values of a velocity function derived from the recorded signal is a specified signal feature, the velocity function representing the velocity of the structure-borne vibration represented by the recorded signal.

18. The measuring and analytical device as recited in claim 16,
wherein
a frequency distribution of analytical function values at the points of local extreme values of a velocity function derived from the recorded signal is a specified signal feature, the velocity function representing the velocity of the structure-borne vibration represented by the recorded signal.

19. The measuring and analytical device as recited in claim 16,
wherein
the data and program memory (13; 14), arithmetic unit (12), and output means (15) are integrated in a portable, hand-held device, and the sensor (20)—as an external element—may be connected thereto using a cable or wireless connection.
